(19) United States
(12) Patent Application Publication
(10) Pub. No.: US 2025/0038854 A1
(43) Pub. Date: Jan. 30, 2025

(54) DUAL LASER CONTROL FOR POINT-TO-MULTIPOINT NETWORKS USING BI-DIRECTIONAL TRANSMISSION

(71) Applicant: Infinera Corporation, San Jose, CA (US)

(72) Inventor: Christopher Fludger, Nuernberg (DE)

(73) Assignee: Infinera Corporation, San Jose, CA (US)

(21) Appl. No.: 18/421,963

(22) Filed: Jan. 24, 2024

Related U.S. Application Data
(60) Provisional application No. 63/440,808, filed on Jan. 24, 2023.

(51) Int. Cl. H04B 10/40; H04B 10/50; H04J 14/02

(52) U.S. Cl. CPC H04B 10/40; H04B 10/505; H04J 14/0226

(57) ABSTRACT

[Consistent with the present disclosure an apparatus and related method are provided for controlling the leaf-receiver local oscillator laser and leaf-transmitter laser for cases where separate transmit and receive local oscillator lasers are included in a transceiver. As a result, full capacity in bidirectional transmission can be realized on a single fiber. The leaf local oscillator frequency is controlled using a feedback signal generated based on an output from the leaf-digital signal processor (DSP), and the leaf transmit laser is controlled using a feedback signal based on an output of the remote hub-DSP, which is carried from the hub to the leaf nodes by a general communication channel (GCC) as part of a data signal, or a separate subcarrier also referred to as an auxiliary channel or out-of-band channel. This ensures that the frequencies transmitted subcarriers from the leaf nodes do not collide or overlap with one another in frequency.

The present patent application hereby claims priority to the provisional patent application identified by U.S. Ser. No. 63/440,808 filed on Jan. 24, 2023, the entire content of which is hereby incorporated by reference.

### BACKGROUND

In a bidirectional optical communication system, optical signals are transmitted in counter-propagating directions along a single fiber. Reflections from connectors, or Rayleigh backscatter can cause coherent crosstalk and degrade performance by creating distortions in the transmitted optical signals. In a conventional optical system including transceivers having both transmitters and receivers, a single laser may be provided, such that part of the light output from the laser is modulated by the transmitter to carry information, and a second portion of the output light is used as a local oscillator for optical signal detection in the receiver.

Point-to-multi-point systems are also known in which a hub transceiver is provided that communicates with multiple leaf transceivers. In such systems, the transmitter and receiver of the leaf transceivers can share a laser, as noted above. In that case, the leaf locks and tunes to the incoming signal from the hub, so that the leaf transmitter is locked to the hub-receiver local oscillator signal. Preferably, the laser frequency of the leaf must be controlled so that transmitted optical signals from the leaf nodes do not interfere with one another, which may happen if such signals have the same frequency of wavelength.

To avoid the degradation from reflections, the hub transmitter may transmit half of available optical signals, such as subcarriers in a downstream direction, and half of the subcarriers are transmitted from the leaf transmitters in an upstream direction, whereby each subcarrier has a different frequency. Due to such frequency diversity, performance is improved, but the overall capacity is halved. That is, the hub transmits half as many subcarriers as would otherwise be transmitted in the absence of the above-described frequency diversity. Similarly, the leaf transmitters collectively transmit half as many subcarriers as would otherwise be transmitted without frequency diversity.

If a separate laser is provided in each transmitter and each receiver of the hub and leaf nodes, the transmitter may be tuned to provide a maximum number of subcarriers that do not overlap in frequency with the subcarriers collectively transmitted by the leaf nodes, which can be similarly tuned to avoid overlapping in frequency with any of the subcarriers transmitted by the hub. As a result, degradation due to reflections does not occur, and a maximum number of subcarriers may be transmitted in both directions in the fiber.

However, since the receiver local oscillator laser is independent of the transmitter laser in the leaf transceiver, there is no frequency reference that can be used to tune the transmitter laser.

Etalons are often employed to control a laser frequency. However, commercially available etalons typically tune to within an accuracy of +/−1.5 GHZ, whereas the transmitter laser frequency often needs to be controlled to within 300-400 MHz. Moreover, as a practical matter, the laser frequency is subject to noise, such that the laser frequency is preferably controlled to have an accuracy of 100-200 MHz.

Although further etalon frequency control accuracy can be achieved by employing tones, such accuracy is limited to 500-600 MHz.

It is therefore highly desirable to have a solution that supports bidirectional transmission using separate transmit and receive lasers, while maintaining a high level of frequency control accuracy in a point-to-multi-point transmission system.

### SUMMARY

Consistent with an aspect of the present disclosure, separate transmit laser and receiver lasers in a point-to-multi-point transmission system whereby east-to-west transmission (uplink) may be at a different frequency than west-to-east (downlink) transmission. In one example, the transmission is bidirectional in one fiber. In addition, a feedback signal is provided via an auxiliary channel from the hub node to control the transmit laser of one or more leaf nodes, and, in a further example, the feedback signal is in an out-of-band channel or, alternatively, is a data signal including a general communication channel (GCC) or other control information provided in the overhead of data frames transmitted from the hub to the leaf nodes. Also, the feedback signal, in a further example, is generated by carrier recovery/frequency locking circuitry provided in the hub.

Moreover, the leaf transmission spectrum associated with optical signals output from the leaf is initially narrowed so that the additional frequency error in an unlocked state does not cause the spectra from two separate leaf nodes to collide or overlap. Such narrowing may be achieved by narrowing the spectra by digital filtering in the leaf transmitter or, in another example, by transmitting fewer subcarriers. Further, consistent with the present disclosure, feedback from the hub node is used to tune the leaf transmit laser. After the leaf transmit laser is tuned, the full spectrum (maximum number of subcarriers) may be output by the leaf transmitter.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) and together with the description, serve to explain the principles of the invention.

### BRIEF DESCRIPTION OF THE DRAWINGS

FIG. 1 is a block diagram of an optical communication network consistent with an aspect of the present disclosure;

FIG. 2 is a block diagram of an optical communication network consistent with a further aspect of the present disclosure;

FIG. 3 shows a schematic of a transmitter consistent with an aspect of the present disclosure;

FIG. 4 shows a schematic of a receiver consistent with an aspect of the present disclosure;

FIGS. 5a and 5b show power spectral density plots consistent with a further aspect of the present disclosure;

FIGS. 6a and 6b show additional spectral density plots consistent with an aspect of the present disclosure;

FIG. 7 shows a spectral density plot consistent with an additional aspect of the present disclosure;

FIGS. 8a to 8d show further power spectral density plots consistent with the present disclosure;

FIG. 9 shows a schematic of a digital signal processor consistent with an aspect of the present disclosure; and

FIGS. 10 and 11 show features of a digital signal processor consistent with an additional aspect of the present disclosure.

### DESCRIPTION OF THE EMBODIMENTS

Consistent with the present disclosure an apparatus and related method are provided for controlling the leaf-receiver local oscillator laser and leaf-transmitter laser for cases where separate transmit and receive local oscillator lasers are included in a transceiver. As a result, full capacity in bidirectional transmission can be realized on a single fiber. The leaf local oscillator frequency is controlled using a feedback signal generated based on an output from the leaf-digital signal processor (DSP), and the leaf transmit laser is controlled using a feedback signal based on an output of the remote hub-DSP, which is carried from the hub to the leaf nodes by a general communication channel (GCC) as part of a data signal, or a separate subcarrier also referred to as an auxiliary channel or out-of-band channel. This ensures that the frequencies transmitted subcarriers from the leaf nodes do not collide or overlap with one another in frequency.

Consistent with a further aspect of the present disclosure, a technique is provided for adding and removing subcarriers where the feedback signal is not yet present and the initial leaf transmit laser accuracy is poor.

Reference will now be made in detail to the present exemplary embodiments of the present disclosure, which are illustrated in the accompanying drawings. Wherever possible, the same reference numbers will be used throughout the drawings to refer to the same or like parts.

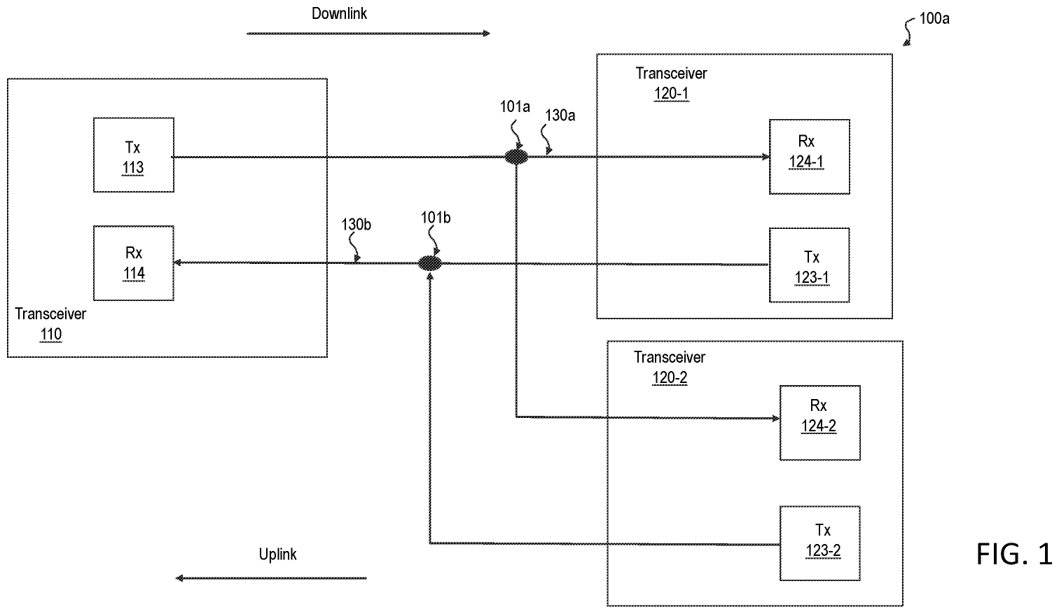

FIG. 1 shows an example of a block diagram of a point-to-point optical communication network 100a, which includes a hub transceiver 110 and leaf transceivers 120-1 and 120-2. Although only two leaf transceivers are shown, it is understood that more than two leaf transceivers are contemplated herein. Hub transceiver 110 includes a transmitter 113 and a receiver 114. In a downlink direction, transmitter 113 outputs a modulated optical signal including a plurality of optical subcarriers, each of which being, in one example, a Nyquist subcarrier. The modulated optical signal including optical subcarriers propagate along optical fiber 130a to a splitter 101a, for example, which supplies a portion of the modulated to receiver 124-1 of leaf transceiver 120-1 and another portion to receiver 124-2 of leaf transceiver 120-2.

Leaf transceiver 120-1 includes receiver 124-1 that receives the first portion of the modulated optical signal from splitter 101a, and leaf transceiver 120-2 includes receiver 124-2 that receives a second portion of the modulated optical signal from splitter 101a.

In an uplink direction leaf transmitters 123-1 and 123-2 supply first and second modulated optical signals, each including a respective grouping (first grouping from transmitter 123-1 and a second grouping from transmitter 123-2) of optical subcarriers to combiner 101b, which combines the first and second groupings of optical subcarriers onto optical fiber 130b. The first and second groups of optical subcarriers are then supplied to hub receiver 114 of transceiver 110. Power spectral density plots of the downlink and uplink subcarriers are described in greater, as well as circuitry included in the transmitters and receivers of the hub and leaf nodes.

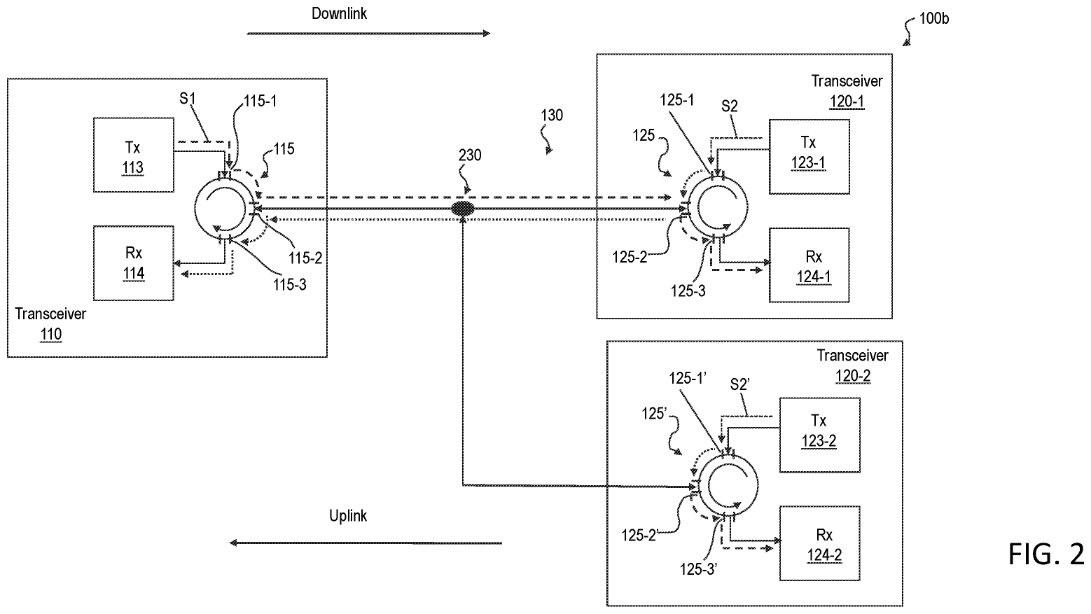

It is noted that optical communication system 100a includes two fibers 130a and 130b that carry optical signals in different directions. FIG. 2 shows an example of a bidirectional optical communication system 100b in which optical signals counter-propagate or travel in two different directions in the same fiber.

In the downlink direction and as discussed in greater detail below, the hub transmitter 113 is configured to modulate the received optical signal output from a laser based on information input or supplied to transmitter 113. Transmitter 113, accordingly, provides a modulated optical signal S1 including, in one example, at least one optical subcarrier. In other examples, however, the modulated optical signal includes multiple optical subcarriers, as noted above. As further shown in FIG. 2, the modulated optical signal S1, including one or more optical subcarriers, is provided to a first port 115-1 of optical circulator 115. The modulated optical signal S1 is then output from second port 115-2 of optical circulator 115 onto bidirectional optical fiber link 130 and is transmitted to a splitter/combiner 230, which supplies a first portion of modulated optical signal S1 to port 125-2 of circulator 125 in leaf transceiver 120-1.

The first portion of modulated optical signal S1 is next directed out of port 125-3 to receiver 124-1, where signal S1 is mixed with the second portion of the optical signal supplied by a laser discussed in greater detail below. The resulting mixing products are converted to electrical signals. Based on such electrical signals and following further processing in receiver 124-1, the information input to transmitter 113 is output from receiver 124-1.

In the uplink direction, transmitter 123-1 in leaf transceiver 120-1 is configured to modulate an optical signal output from a laser in transmitter 123-1 based on information input or supplied to transmitter 123-1, as discussed in greater detail below. Transmitter 123-1, therefore, provides a modulated optical signal S2 including, in one example, at least one optical subcarrier. In other examples, however, modulated optical signal S2 includes multiple optical subcarriers. As further shown in FIG. 2, the modulated optical signal S2 is provided to a first port 125-1 of optical circulator 125. The modulated optical signal S2 then is output from second port 125-2 of optical circulator 125 onto bidirectional optical fiber link 130 and is transmitted toward port 115-2 of circuit 115 in hub transceiver 110 via splitter/combiner 230.

Modulated optical signal S2 is next directed out of port 115-3 to receiver 114, where signal S2 is mixed with a local oscillator optical signal supplied by a laser in receiver 114. The resulting mixing products are converted to electrical signals. Based on such electrical signals and following further processing in receiver 124, the information input to transmitter 123 is output from receiver 114.

Splitter combiner 230 also supplies a second portion of modulated optical signal S1 to port 125-2′ of leaf transceiver 120-2. The second portion of modulated optical signal S1 output is next directed out of port 125-3′ to receiver 124-1′, where signal S1 is mixed with the second portion of the optical signal supplied by a laser discussed in greater detail below. The resulting mixing products are converted to electrical signals. Based on such electrical signals and following further processing in receiver 124-1′, the information input to transmitter 113 is output from receiver 124-1.

In a similar manner in the uplink direction, transmitter 123-1′ in leaf transceiver 120-2 is configured to modulate an optical signal output from a laser in transmitter 123-1′ based on information input or supplied to transmitter 123-1′, as discussed in greater detail below. Transmitter 123-1′, therefore, provides a modulated optical signal S2′ including, in one example, at least one optical subcarrier. In other examples, however, modulated optical signal S2′ includes multiple optical subcarriers. As further shown in FIG. 2, the modulated optical signal S2′ is provided to a first port 125-1′ of optical circulator 125′. The modulated optical signal S2′ then is output from second port 125-2′ of optical circulator 125′ to splitter/combiner 230, which combines signal S2′ with signal S2 and provides the combined signal to port 115-2 of circulator 115 via bidirectional optical fiber link 130.

Modulated optical signal S2′, along with signal S2, is next directed out of port 115-3 to receiver 114, where signal S2 is mixed with a local oscillator optical signal supplied by a laser in receiver 114. The resulting mixing products are converted to further electrical signals. Based on such electrical signals and following further processing in receiver 124, the information input to transmitter 123 is output from receiver 114.

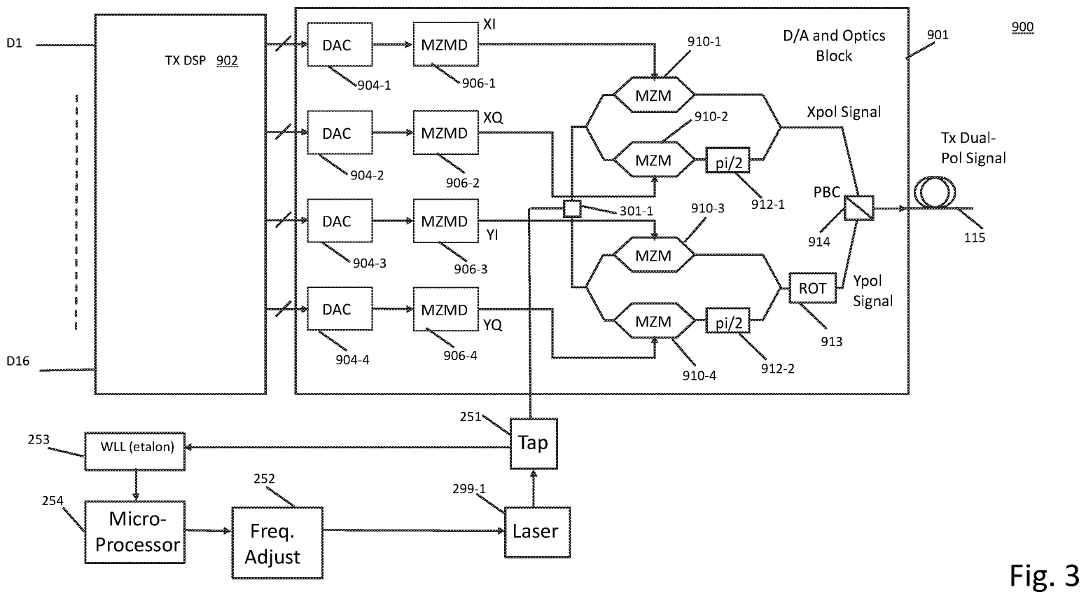

FIG. 3 is a diagram illustrating transmitter 900, in accordance with one or more implementations of the present disclosure. The transmitters 113-1, 123-1, and 123-2 discussed previously with reference to FIGS. 1-2, can include the transmitter 900. Further, as noted above, the number of optical subcarriers output from each transmitter may be changed dynamically, for example, depending on capacity requirements. A mechanism for facilitating control of the number of transmitted optical subcarriers also is described in greater detail below.

The transmitter 900 includes a digital signal processor (DSP) 902, which, in the illustrated implementation, has multiple data inputs D1-D16. Based on data inputs D1-D16, the DSP 902 provides multiple outputs (for example, electrical signals) to D/A and optics block 901, including digital-to-analog conversion (DAC) circuits 904-1 to 904-4, which convert digital signals received from DSP 902 into corresponding analog signals. D/A and optics block 901 also includes driver circuits 906-1 to 906-2 that receive the analog signals from DACs 904-1 to 904-4 and adjust the voltages or other characteristics thereof to provide drive signals to a corresponding one of modulators 910-1 to 910-4.

Further details of DSP 902 are described below, as well as a mechanism for selectively varying the spectral width of a subcarrier and the number of subcarriers.

Returning to FIG. 3, D/A and optics block 901 further includes modulators 910-1 to 910-4, each of which may be, for example, a Mach-Zehnder modulator (MZM) that modulates the phase and/or amplitude of the light output from laser 299-1 via tap 251. In some instances, the modulators 910-1 to 910-4 may collectively be referred to as a single modulator 910. In the illustrated implementation, light output from tap 251 split by a splitter 301-1, such that a first portion of the light is supplied to a first MZM pairing including MZMs 910-1 and 910-2 and a second portion of the light is supplied to a second MZM pairing including MZMs 910-3 and 910-4. The first portion of the light is further split into third and fourth portions, such that the third portion is modulated by MZM 910-1 to provide an in-phase (I) component, for example, of an X (or TE) polarization component of a modulated optical signal, and the fourth portion is modulated by MZM 910-2 and fed to phase shifter 912-1 to shift the phase of such light by 90 degrees in order to provide a quadrature (Q) component, for example, of the X polarization component of the modulated optical signal. Similarly, the second portion of the light is further split into fifth and sixth portions, such that the fifth portion is modulated by MZM 910-3 to provide an I component, for example, of a Y (or TM) polarization component of the modulated optical signal, and the sixth portion is modulated by MZM 910-4 and fed to phase shifter 912-2 to shift the phase of such light by 90 degrees to provide a Q component, for example, of the Y polarization component of the modulated optical signal.

The optical outputs of MZMs 910-1 and 910-2 are combined to provide an X polarized optical signal including I and Q components and fed to a polarization beam combiner (PBC) 914 provided in block 901. In addition, the outputs of MZMs 910-3 and 910-4 are combined to provide an optical signal that is fed to polarization rotator 913, further provided in block 901, which rotates the polarization of such optical signal to provide a modulated optical signal having a Y (or TM) polarization. The Y polarized modulated optical signal is also provided to PBC 914, which combines the X and Y polarized modulated optical signals to provide a polarization multiplexed (“dual-pol”) modulated optical signal (S1), including optical subcarriers, to circulator port 115-1, for example, if transmitter 900 is provided as hub transmitter 113. If transmitter 900 is provided in transmitter 123-1, however, the transmitter output S2 would be supplied to circulator port 125-1, and, if transmitter 900 is provided in transmitter 123-2, output S2′ is provided to circulator port 125-1′.

In the illustrated example, the polarization multiplexed optical signal output from D/A and optics block 901 includes eight subcarriers SC1-SC16, for example, such that each subcarrier has X and Y polarization components and I and Q components. Moreover, each subcarrier SC1-SC16 may be associated with or corresponds to a respective one of the data inputs D1-D16.

As further shown in FIG. 3, tap 251 also provides a portion of the light output from laser 299-1 to a wavelength locker WLL circuit 253 including an etalon. The optical output of WLL circuit 253 is converted to electrical signals, which, in turn, are converted to digital signals that are supplied to microprocessor 254. The microprocessor 254 provides control signal to frequency adjusting circuitry 252 for adjusting or controlling the frequency of light output from laser 299-1. In one example, circuitry 252 includes a current source that supplies current to laser 299-1, such that the current is controlled base on the output of microprocessor 254 and thus the temperature of laser 299-1 and the frequency of light output from laser 299-1. In another example, circuitry 252 includes heaters that are thermally coupled to laser 299-1 to adjust the temperature (and the frequency of light output from laser 299-1) based on the outputs of microprocessor 254.

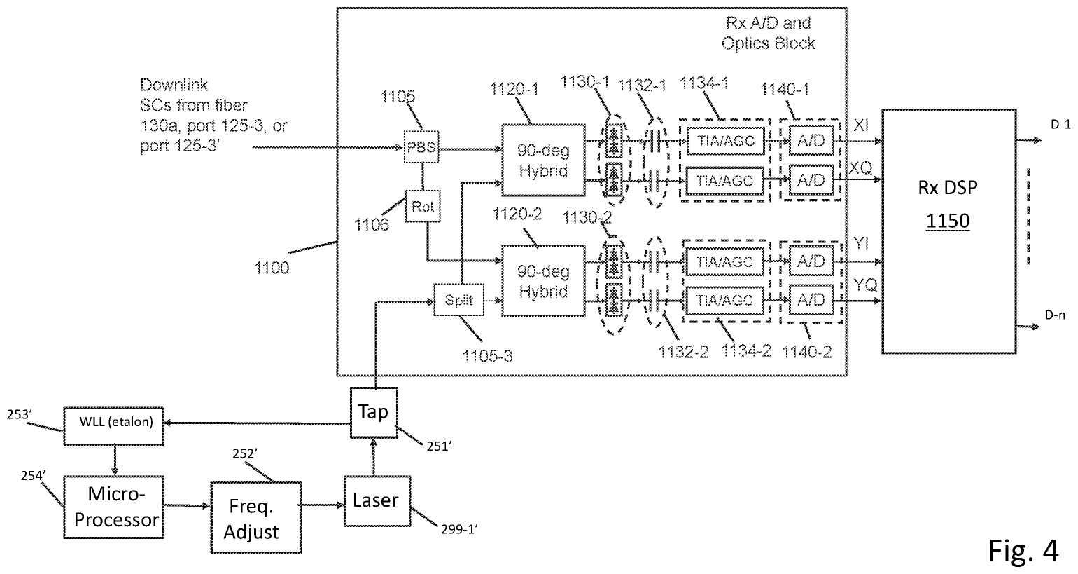

FIG. 4 is a diagram illustrating an example of a receiver 1100, in accordance with one or more implementations of the present disclosure. The receivers 114, 124-1, and 124-1′ described previously with reference to FIGS. 1-2 can include the receiver 1100. The receiver 1100 includes an Rx optics and A/D block 1101, which, in conjunction with DSP 1150, can carry out coherent detection. Block 1101 includes a polarization beam splitter (PBS) 1105 with first (1105-1) and second (1105-2) outputs, a local oscillator (LO) laser 299-1′, 90-degree optical hybrids or mixers 1120-1 and 1120-2 (referred to generally as hybrid mixers or optical hybrid circuits 1120 and individually as hybrid mixer or optical hybrid circuit 1120), detectors 1130-1 and 1130-2 (referred to generally as detectors or photodiode circuits 1130 and individually as detector or photodiode circuit 1130, each including either a single photodiode or balanced photodiode), AC coupling capacitors 1132-1 and 1132-2, trans-impedance amplifiers/automatic gain control circuits TIA/AGC 1134-1 and 1134-2, ADCs 1140-1 and 1140-2 (referred to generally as ADCs 1140 and individually as ADC 1140), and an RX DSP 1150. Laser 299-1′ provides local oscillator light by way of tap 251′ to splitter 1105-3.

Polarization beam splitter (PBS) 1105 can include a polarization splitter that receives an input polarization multiplexed optical signal including one or more optical subcarriers SC1 to SC16 supplied by optical fiber link 130a or one of the circulator port discussed above (125-3 or 125-3′). PBS 1105 can split the incoming optical signal into the two X and Y orthogonal polarization components. The Y component may be supplied to a polarization rotator 1106 that rotates the polarization of the Y component to have the X polarization. Hybrid mixers 1120 can combine the X and rotated Y polarization components with light from local oscillator laser 1110. For example, hybrid mixer 1120-1 can combine a first polarization signal (e.g., the component of the incoming optical signal having a first or X (TE) polarization output from PBS port 1105-1) with light from local oscillator 1110, and hybrid mixer 1120-2 can combine the rotated polarization signal (e.g., the component of the incoming optical signal having a second or Y (TM) polarization output from PBS port 1105-2) with the local oscillator light from tap 251′. In one example, polarization rotator 1190 may be provided at PBS output 1105-2 to rotate Y component polarization to have the X polarization.

Detectors 1130 can detect mixing products output from the optical hybrids, to form corresponding voltage signals, which are subject to AC coupling by capacitors 1132-1 and 1132-1, as well as amplification and gain control by TIA/AGCs 1134-1 and 1134-2. The outputs of TIA/AGCs 1134-1 and 1134-2 and ADCs 1140 can convert the voltage signals to digital samples. For example, two detectors or photodiodes 1130-1 can detect the X polarization signals to form the corresponding voltage signals, and a corresponding two ADCs 1140-1 may convert the voltage signals to digital samples for the first polarization signals after amplification, gain control and AC coupling. Similarly, two detectors 1130-2 may detect the rotated Y polarization signals to form the corresponding voltage signals, and a corresponding two ADCs 1140-2 may convert the voltage signals to digital samples for the second polarization signals after amplification, gain control and AC coupling. RX DSP 1150 may process the digital samples associated with the X and Y polarization components to output data D1 to D8 associated with subcarriers SC1 to SC8.

While FIG. 4 shows the receiver 1100 as including a particular number and arrangement of components, in some implementations, optical receiver 1100 includes additional components, fewer components, different components, or differently arranged components. The number of detectors 1130 and/or ADCs 1140 can be selected to implement an optical receiver 1100 that is capable of receiving a polarization multiplexed signal.

Consistent with the present disclosure, in order to demodulate one or more of subcarriers SC1 to SC16, the local oscillator light local oscillator 1110 may be tuned to output light having a wavelength or frequency relatively close to one or more of the subcarrier wavelengths or frequencies to thereby cause a beating between the local oscillator light and the subcarriers.

Thus, in a manner similar to that described with reference to FIG. 3, tap 251′ also provides a portion of the light output from laser 299-1′ to a wavelength locker WLL circuit 253′ including an etalon. The optical output of WLL circuit 253′ is converted to electrical signals, which, in turn, are converted to digital signals that are supplied to microprocessor 254′. The microprocessor 254′ provides control signal to frequency adjusting circuitry 252′ for adjusting or controlling the frequency of light output from laser 299-1′. In one example, circuitry 252′ includes a current source that supplies current to laser 299-1′, such that the current is controlled base on the output of microprocessor 254′ and thus the temperature of laser 299-1′ and the frequency of light output from laser 299-1′. In another example, circuitry 252′ includes heaters that are thermally coupled to laser 299-1′ to adjust the temperature (and the frequency of light output from laser 299-1′) based on the outputs of microprocessor 254′.

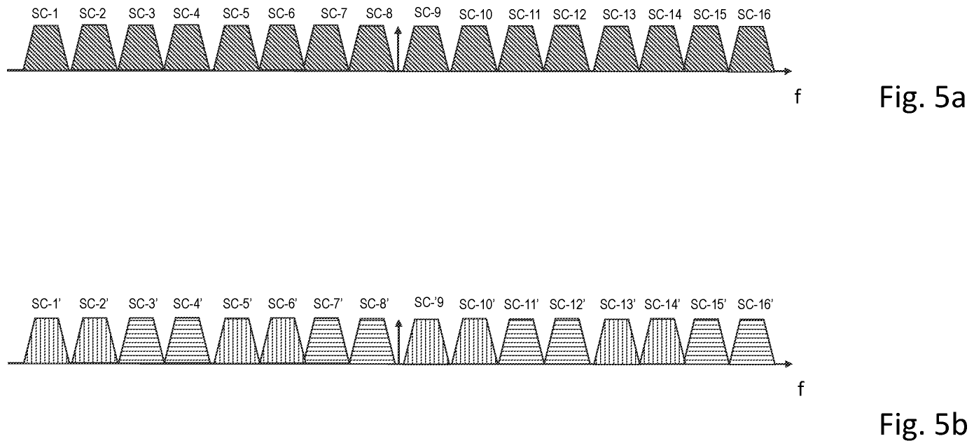

FIG. 5a illustrates a power spectral density plot of optical subcarriers SC-1 to SC-16, which, in the above example, are included in modulated optical signal S1. Such optical subcarriers may also be output from hub transmitter 113.

FIG. 5b illustrates a power spectral density plot of subcarriers SC-1′ to SC-16′ output from leaf transmitter 123-1 and 123-2. Namely, in this example, subcarriers SC-1′, SC-2′, SC-5′, SC-6′, SC-9′, SC-10′, SC-13′, and SC-14′ are output from leaf transmitter 123-1. In addition, subcarriers SC-3′, SC-4′, SC-7′, SC-8′, SC-11′, SC-12′, SC-15′, and SC-16′ are output from leaf transmitter 123-2.

Returning to the example shown in FIG. 1, both hub (110) and leaf transceivers (120-1, 120-2) use separate transmitter and receiver lasers. Here, a separate fiber for each direction, but a single fiber can also be used, as further noted above with respect to FIG. 2.

In FIG. 1, the hub transmit and receiver lasers are locked to a respective etalon in the WLL 253 in FIG. 3 and WLL 253′ in FIG. 4 reference with +/−1.5 GHZ accuracy and can be placed at different frequencies so that bidirectional transmission does not result in degradation due to reflections. For example, the transmit laser output signal is at 194.000 THz, for example, and the local oscillator (LO) frequency is 100 GHz away at 194.100 THz. If separate fibers are used, the laser frequencies may be nominally the same if desired.

Consistent with an aspect of the present disclosure the leaf receiver laser is tuned to lock to the hub transmit laser using a local feedback signal from the carrier phase estimator in the leaf-DSP discussed in greater detail below.

Circuitry in the hub receiver DSP measures the frequency error between the local oscillator signal and the incoming subcarriers from each leaf node. The hub LO laser is not tuned but passes an error signal back to the remote leaf transceivers 120-1 and 120-2 via an auxiliary data channel, such as a GCC, or out-of-band optical subcarrier, an optical subcarrier, which, in one example, is dedicated for carrying control information. Such data channel and out of band subcarriers are described in U.S. Patent Application Publication No. 2021/0091873, the entire contents of which are incorporated herein by reference. The leaf nodes therefore receive a feedback signal for controlling the transmit lasers in each leaf node transceivers 123-1 and 123-2. Namely, the leaf transmit laser uses the frequency error signal from the hub to correct its Tx laser frequency.

In the above examples, the feedback signal from hub-to-leaf is placed on an out-of-band channel or designated subcarrier, which is an out-of-band amplitude modulated signal applied to the optical subcarrier as described in the above-noted U.S Patent Application Publication No. 2021/0091873. Although FIG. 5b shows the leaf node transmitters 123-1 and 123-2 supplying alternating groups of two subcarriers, it is contemplated that any combination and number of leaf-nodes may be applied.

The feedback signal noted above may be delayed by the latency of the fiber (80 km of fiber results in a delay of 400 microseconds). Target application is for PON networks with distances <<80 km). Additionally, there may be a delay from the auxiliary channel and any microprocessor calculations or processing (1 to 10 milliseconds). Typically, the laser frequency control loop including WLL 253, microprocessor 254, and frequency adjusting circuitry 252, for example, is updated every 50 ms, such that this delay is not significant for the control loop.

FIG. 2, as noted above, shows a bidirectional optical communication system. Circulators and a splitter/combiner can be used to separate the transmit and receive directions. By separating the uplink and downlink transmission directions and using separate lasers, such that the uplink and downlink optical subcarriers do not overlap in frequency, the above-noted problem of performance degradation due to reflected light is removed. As a result, full capacity or the maximum number of optical subcarriers can be transmitted in both directions.

When a leaf laser begins transmitting to the hub, no feedback signal is sent from the hub to control the transmit laser frequency. At this point, control of the transmit laser frequency will rely on the local etalon and WLL accuracy which could give up to 1.5 GHz of frequency error.

In a scenario where there is frequency space or gap for a new leaf transmitter to supply optical signals or subcarriers having frequencies in that gap. This gap will be present in the spectrum detected at the hub. If the new leaf begins transmission of a subcarrier, for example, the accuracy of its etalon may be insufficient to control the frequency of the newly added subcarrier that it does not collide or overlap with an existing subcarrier, thereby resulting in optical signal loss for both the existing and newly added optical subcarriers.

Consistent with the present disclosure, therefore, the spectral width of the subcarrier output from the newly added leaf is narrowed e.g. by using a different digital transmit filter, as described below, the frequency error from the etalon will not result in spectra collisions.

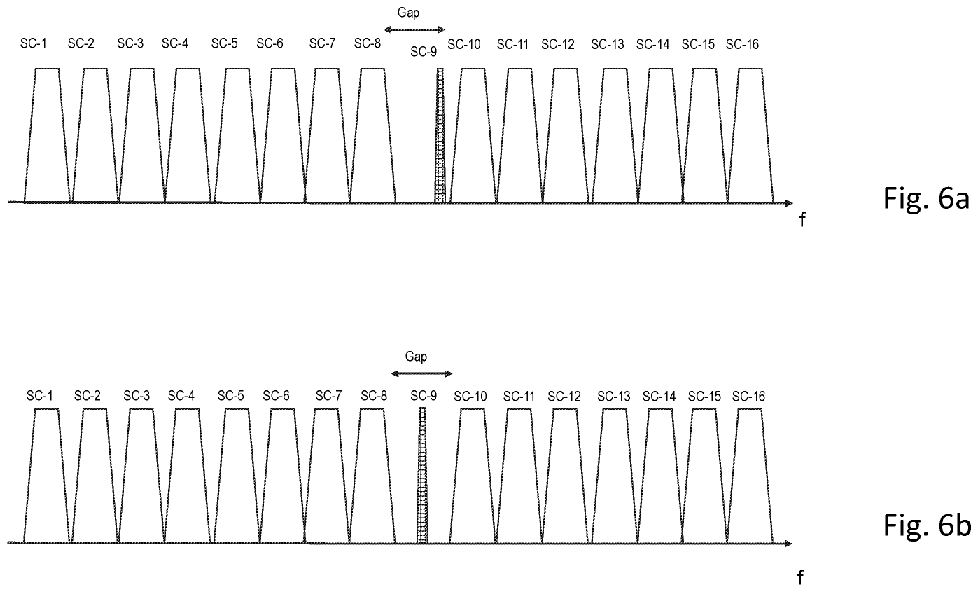

For example, as shown in FIG. 6a, subcarrier SC-9 is transmitted by a newly added leaf transmitter and subcarriers Sc-1 to SC-8 and SC-10 to SC-16 are pre-existing, i.e., were transmitted by various leaf nodes prior to the addition of the new lead. Here, the spectrum associated with subcarrier SC-9 is narrowed to be less than that of each of the pre-existing subcarriers.

The hub can then measure the frequency error by measuring the power spectral density of the received signal, or using carrier recovery based on this lower bandwidth signal. This is then fed-back to the leaf in the auxiliary channel (out-of-band or GCC) so that the leaf can correctly center the transmit laser provided in the leaf. For example, as shown in FIG. 6b, the frequency of subcarrier SC-9 is shifted relative to the frequency of SC-9 in FIG. 6a. In particular, the frequency of subcarrier SC-9 is shifted to be centered within the gap between the frequencies of subcarriers SC-8 and SC-10.

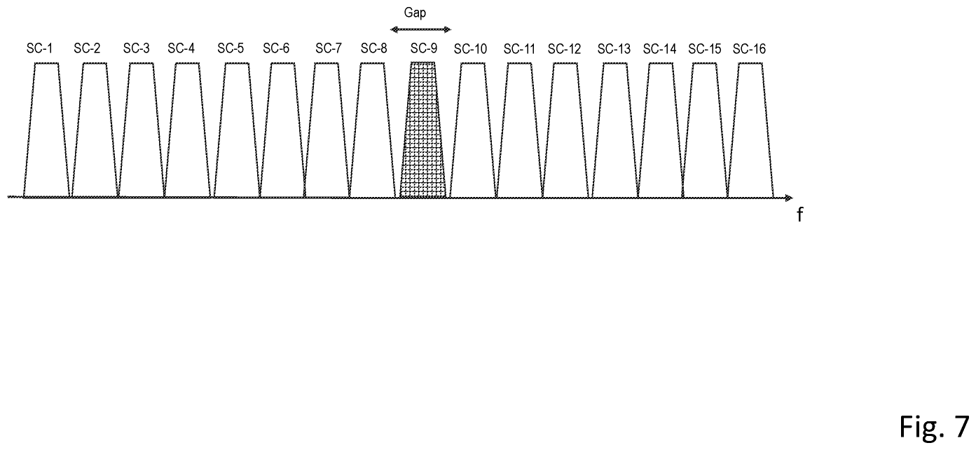

Once the leaf transmit laser is correctly tuned, it can switch to transmitting the full bandwidth subcarrier. For example, as shown in FIG. 7, the spectral width of subcarrier SC-9 is expanded to occupy the gap between subcarriers SC-8 and SC-10.

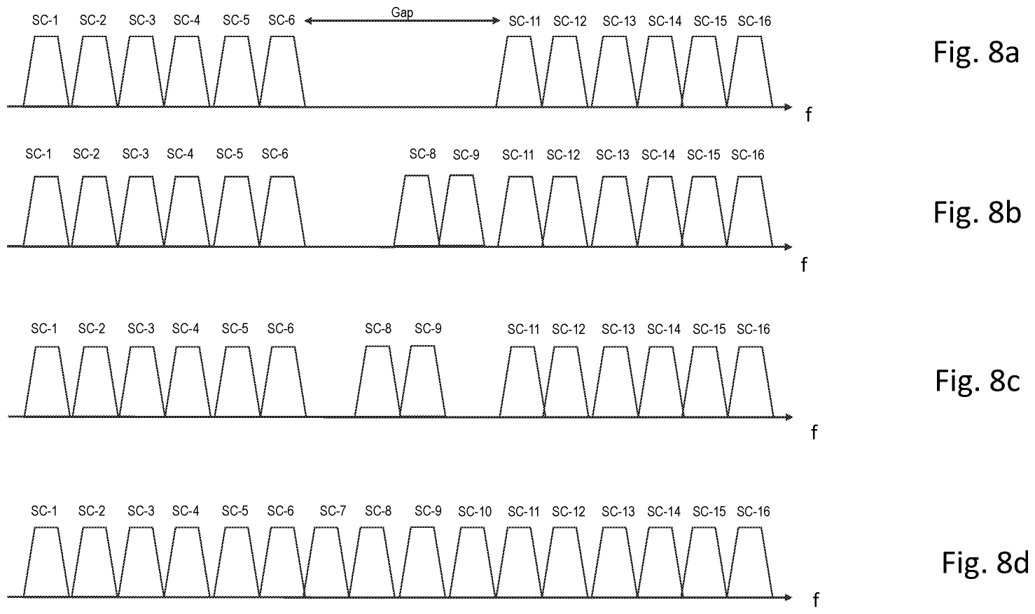

The scheme may also be adapted when there is more than one subcarrier being deployed. Here, the spectrum of the newly added subcarriers need not be narrowed, but rather multiple subcarriers may be switched off or blocked. This may be advantageous in terms of practicality and use of existing hardware functions. In the example shown in FIGS. 8a-8d is a gap corresponding to four subcarriers, SC-7 to SC-10, to be added to pre-existing subcarriers SC-1 to SC-6 and SC-11 to SC-16.

As shown in FIG. 8a, initially, each of subcarriers SC-7 to SC-10 are deactivated. In FIG. 8b, however, the leaf initially activates two subcarriers, for example, SC-9 and SC-10, so that the frequency error when using an etalon doesn't result in these subcarriers overlapping with the pre-existing subcarriers. The hub then provides a feedback signal to the leaf via the auxiliary channel noted above so that the leaf can remove the frequency error and center the newly added subcarriers SC-9 and SC-10 in the gap (FIG. 8c).

Next, once the frequency error has been removed, the leaf can activate each of subcarriers SC-7 to SC-11 to achieve full capacity (see FIG. 8d). The leaf continues to correct for frequency errors by adjusting its transmit laser using feedback from the remote hub.

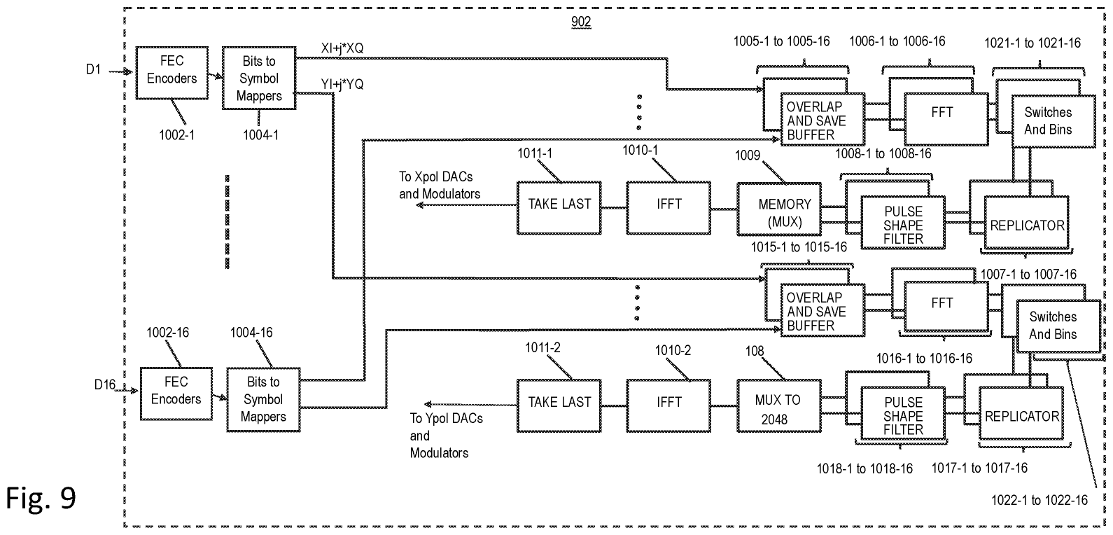

Before discussing an example implementation for blocking or deactivating particular subcarriers or alternatively varying the width of a subcarrier, details of transmit DSP 902 will next be described with reference to FIG. 9.

FIG. 9 is a diagram illustrating an example of the transmitter DSP 902 (TX-DSP) included in the transmitter 900 of FIG. 3. In accordance with one or more implementations of the present disclosure. TX DSP 902 includes forward error correction (FEC) encoders 1002-1 to 1002-16, each of which may receive one or more of a respective one of a plurality of the data inputs D1 to D16. FEC encoders 1002-1 to 1002-16 carry out forward error correction coding on a corresponding one of the data input D1 to D16, such as, by adding parity bits to the received data. The FEC encoders 1002-1 to 1002-16 also are capable of providing timing skew between the subcarriers to correct for skew introduced during transmission over one or more optical fibers. In addition, the FEC encoders 1002-1 to 1002-16 are capable of interleaving the received data.

Each of the FEC encoders 1002-1 to 1002-16 provides an output to a corresponding one of a plurality of bits-to-symbol circuits, 1004-1 to 1004-16 (collectively referred to herein as “bits-to-symbol circuits 1004”). Each of the bits-to-symbol circuits 1004 is capable of mapping the encoded bits to symbols on a complex plane. For example, bits-to-symbol circuits 1004 can map four bits to a symbol in a dual-polarization quadrature phase shifting key (QPSK) constellation. Each of the bits-to-symbol circuits 1004 provides first symbols, having the complex representation XI+j*XQ, associated with a respective one of the data input, such as D1, to DSP portion 1003. Data indicative of such first symbols may carried by the X polarization component of each subcarrier SC1-SC8 (described previously).

Each of the bits-to-symbol circuits 1004 can further provide second symbols having the complex representation YI+j*YQ, also associated with a corresponding one of data inputs D1 to D8. Data indicative of such second symbols, however, can be carried by the Y polarization component of each of subcarriers SC1 to SC8.

Each of the first symbols output from each of bits-to-symbol circuits 1004 is supplied to a respective one of first overlap and save buffers 1005-1 to 1005-16 (collectively referred to herein as overlap and save buffers 1005) that may buffer 256 symbols, for example. Each of the overlap and save buffers 1005 can receive 128 of the first symbols or another number of such symbols at a time from a corresponding one of bits to symbol circuits 1004. Thus, the overlap and save buffers 1005 can combine 128 new symbols from the bits-to-symbol circuits 1005, with the previous 128 symbols received from the bits-to-symbol circuits 1005.

Each overlap and save buffer 1005 supplies an output, which is in the time domain, to a corresponding one of fast Fourier Transform (FFT) circuits 1006-1 to 1006-16 (also referred to individually or collectively as FFTs or FFT circuits 1006). In the illustrated implementation, the output includes 256 symbols or another number of symbols. Each of the FFTs 1006 converts the received symbols to the frequency domain using or based on, for example, a fast Fourier transform. Each of the FFTs 1006 output frequency data can be transmitted to switches and bins circuitry 1021-1 to 1021-16, each of which can include a switch and 256 memories or registers, also referred to as frequency bins or points, which store frequency components associated with the input symbols converted by the FFTs 1006. Each of the replicator components 1007-1 to 1007-16 is capable of replicating the 256 frequency components associated with the switches and bins circuitry 1021-1 to 1021-16 and storing such components in 512 or another number of frequency bins (for example, for T/2 based filtering of the subcarrier) in a respective one of the plurality of replicator components. Such replication can increase the sample rate. In addition, replicator components or circuits 1007-1 to 1007-16 can arrange or align the contents of the frequency bins to fall within the bandwidths associated with pulse shaped filter circuits 1008-1 to 1008-16.

Each of the pulse shape filter circuits 1008-1 to 1008-16 is capable of applying a pulse shaping filter to the data stored in the 512 frequency bins of a respective one of the plurality of replicator components 1007-1 to 1007-16 to thereby provide a respective one of a plurality of filtered outputs, which are multiplexed and subject to an inverse FFT, as described later. Pulse shape filter circuits 1008-1 to 1008-16 calculate the transitions between the symbols and the desired subcarrier spectrum so that the subcarriers can be spectrally packed together for transmission (for example, with a close frequency separation). Pulse shape filter circuits 1008-1 to 1008-16 can also be used to introduce timing skew between the subcarriers SC1 to SC8 to correct for timing skew induced by optical links. Multiplexer component 1009, which can include a multiplexer circuit or memory, can receive the filtered outputs from pulse shape filter circuits 1008-1 to 1008-16, and multiplex or combine such outputs together to form an element vector.

Inverse fast Fourier transform (IFFT) circuit or component 1010-1 is capable of receiving the element vector and providing a corresponding time domain signal or data based on an IFFT. In some implementations, the time domain signal includes a rate of 64 GSample/s. For example, last buffer or memory circuit 1011-1 can select the last 1024 or another number of samples from an output of IFFT component or circuit 1010-1 and supply the samples to DACs 904-1 and 904-2 at 64 GSample/s, for example. As noted previously, DAC 904-1 is associated with the in-phase (I) component of the X pol signal and DAC 904-2 is associated with the quadrature (Q) component of the Y pol signal. Accordingly, consistent with the complex representation XI+jXQ, DAC 904-1 receives values associated with XI and DAC 904-2 receives values associated with jXQ. Based on these inputs, DACs 904-1 and 904-2 provide analog outputs to MZMD 906-1 and MZMD 906-2, respectively, as discussed previously.

Each of the bits-to-symbol circuits 1004-1 to 1004-16 outputs a corresponding one of symbols indicative of data carried by the Y polarization component of the polarization multiplexed modulated optical signal output on fiber 916. As previously indicated, these symbols can have the complex representation YI+j*YQ. Each such symbol can be processed by a respective one of overlap and save buffers 1015-1 to 1015-16, a respective one of FFT circuits 1016-1 to 1016-16, a respective one of replicator components or circuits 1017-1 to 517-16, pulse shape filter circuits 1018-1 to 1018-16, multiplexer or memory 1019, IFFT 1010-1, and take last buffer or memory circuit 1011-1, to provide processed symbols having the representation YI+j*YQ in a manner similar to or the same as that discussed above in generating processed symbols XI+j*XQ output from take last circuit 1011-1. In addition, symbol components YI and YQ are provided to DACs 904-3 and 904-4, respectively. Based on these inputs, DACs 904-3 and 904-4 provide analog outputs to MZMD 906-3 and MZMD 906-4, respectively, as discussed above.

While FIG. 4 shows DSP 902 as including a particular number and arrangement of functional components, in some implementations, DSP 902 can include additional functional components, fewer functional components, different functional components, or differently arranged functional components. In addition, typically the number of overlap and save buffers, FFTs, replicator circuits, and pulse shape filters associated with the X component may be equal to the number of data inputs, and the number of such circuits associated with the Y component may also be equal to the number of switch outputs. However, in other examples, the number of data inputs may be different from the number of these circuits.

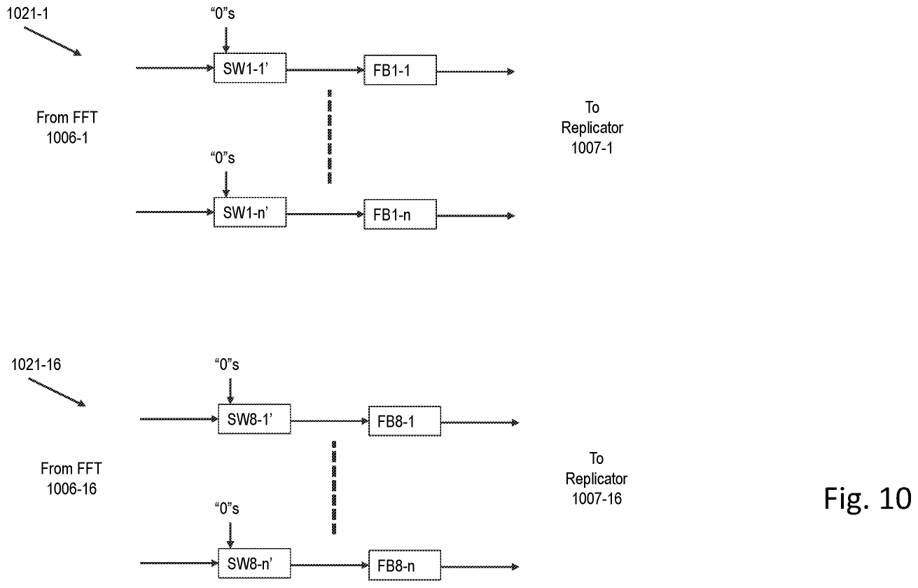

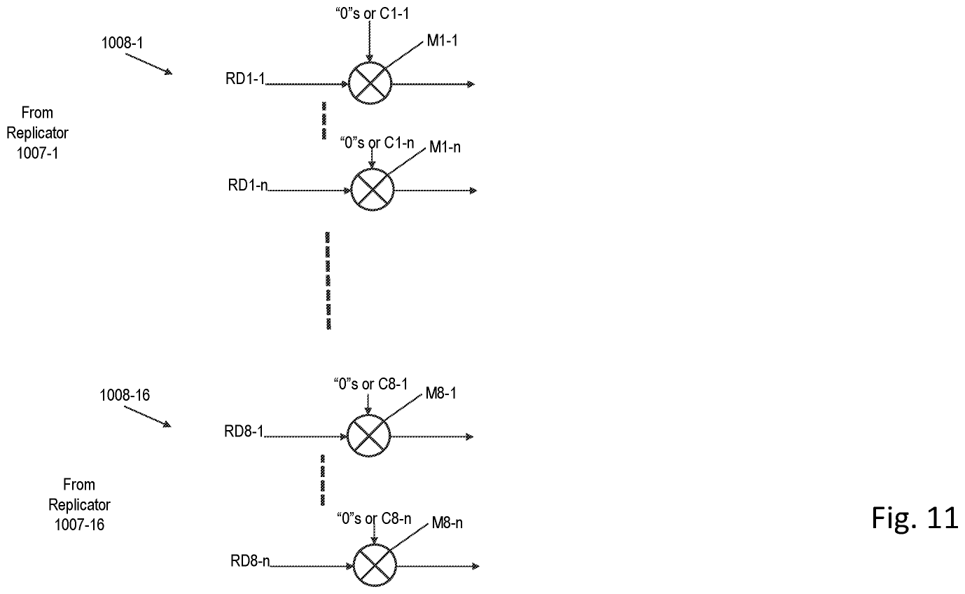

As previously indicated, the spectral width of a subcarrier may be controlled during initial activation to be narrow and then widened, once the subcarrier frequency is spectrally centered within the above-noted gap based on feedback from the hub. In addition, newly added subcarriers may be initially deactivated, followed by activation of a limited number of subcarriers to be added. Such subcarriers are then centered in the spectral gap and the remaining subcarriers to be added are activated. Circuitry in DSP 900 for subcarrier spectral width control and activation and deactivation of subcarriers will next be described with reference to FIGS. 10 and 11.

Transmitter 900 can adjust the spectral width of individual subcarriers and the number of subcarriers output from the transmitter dynamically. In some implementations, a subcarrier can be deactivated by using the switches and bins circuitry 1021-1 to 1021-16, as described in greater detail below in connection with FIG. 10. In some implementations, a subcarrier can be deactivated by using the pulse shape filters 1008-1 to 1008-16, as described in greater detail below in connection with FIG. 11. Such circuitry may also be employed to dynamically control the spectral width of a subcarrier.

As shown in FIG. 10, switches and bin circuitry 1021-1 and 1021-16 includes a plurality of frequency bins (e.g., memories) FB1-1 to FB1-n and FB16-1 to FB16-n, respectively. The plurality of frequency bins FB1-1 to FB1-n and FB16-1 to FB16-n are communicatively coupled to a plurality of switches SW1-1 to SW1-n and SW16-1 to SW16-n, respectively. The plurality of switches SW1-1 to SW1-n and SW8-1 to SW16-n are configured to receive the frequency domain data generated by FFT 1006-1 and 1006-16, respectively. Based on the control signals CNT-1 to CNT-16, the plurality of switches SW1-1 to SW1-n and SW16-1 to SW16-n are configured to either provide the frequency domain data or to provide predetermined data (for example, null or “0” data) to a corresponding one of the plurality of frequency bins FB1-1 to FB1-n and FB8-1 to FB16-n. If the predetermined data is supplied to one of the plurality of frequency bins FB1-1 to FB1-n and FB16-1 to FB16-n, a subcarrier associated with that plurality of frequency bins is deactivated and is not output on the optical link 916. For example, in the illustrated implementation, “0” data is provided by the plurality of switches SW1-1 to SW1-n and SW16-1 to SW8-n to the plurality of frequency bins FB1-1 to FB1-n and FB8-1 to FB16-n, and consequently, drive signals are applied to modulators 910, such that optical subcarriers SC1 and SC8 are deactivated or omitted from the modulated optical signal output onto fiber 916. The spectral width of a subcarrier may similarly be controlled by supplying “0” data to corresponding frequency bins.

FIG. 6 is a diagram illustrating activating and deactivating subcarriers at the transmitter 900 using the pulse shape filters 1008-1 to 1008-16, in accordance with one or more implementations of the present disclosure. The implementation shown in FIG. 6 may be provided as an alternative to the implementation shown in FIG. 5. For illustrative purposes, FIG. 6 shows portions of pulse shape filters 1008-1 and 1008-16 including a plurality of multiplier circuits M1-1 to M1-n and M8-1 to M8-n, respectively, for processing the replicated data RD1-1 to RD1-n and RD8-1 to RD8-n from the replicators 1007-1 and 1007-16, respectively. The plurality of multiplier circuits M1-1 to M1-n and M8-1 to M8-n can process the replicated data RD1-1 to RD1-n and RD8-1 to RD8-n by multiplying the data by “0” or by a predefined value (C1-1 to C1-n and C8-1 to C8-n). If the replicated data from a replicator is multiplied by “0”, the optical subcarrier corresponding to that replicator is deactivated. For example, if the plurality of multipliers M1-1 to M1-n multiply the replicated data RD1-1 to RD1-n by “0”, such that drive signals supplied to modulators 910 result in subcarrier SC1 being deactivated or blocked whereby SC1 is omitted from the modulated optical signal output onto fiber 916. In a similar manner, replicated data associated with spectral width of a particular subcarrier may also be set to “0” to thereby control the spectral width.

Other embodiments will be apparent to those skilled in the art from consideration of the specification. It is intended that the specification and examples be considered as exemplary only, with a true scope and spirit of the invention being indicated by the following claims.

What is claimed is:

1. A method, comprising:
transmitting a plurality of first optical subcarriers, each of which having a respective one of a plurality of first frequencies, and each having a first spectral width;
transmitting a second optical subcarrier having a second frequency and a second spectral width that is less than the first spectral width, the second frequency being in a spectral gap defined by a first one of the plurality of first frequencies and a second one of the plurality of first frequencies;
changing the second frequency to be spectrally in a center of the spectral gap; and
enlarging the second spectral width after said changing the second frequency, such that the second spectral width is equal to the first spectral width.

2. A method comprising:
transmitting a plurality of first optical subcarriers, each of which having a respective one of a plurality of first frequencies;
transmitting a plurality of second optical subcarriers, each of which having a respective one of a plurality of second frequencies, each of the plurality of second frequencies being within a spectral gap defined by a first one of the plurality of first frequencies and a second one of the first plurality of subcarriers;
changing the plurality of second frequencies; and
adding a plurality of third optical subcarriers, each of which having a corresponding one of a plurality of third frequencies, each of the third plurality of frequencies begin within the spectral gap.
